(19) United States
(12) Patent Application Publication
(10) Pub. No.: US 2026/0118058 A1
(43) Pub. Date: Apr. 30, 2026

(54) INTAKE DUCT STRUCTURE FOR LOW DRYER AND BLOW DRYER

(71) Applicant: SHENZHEN PETABOO TECHNOLOGY CO., LTD., SHENZHEN (CN)

(72) Inventor: BOCHAO XU, SHENZHEN (CN)

(21) Appl. No.: 19/009,024

(22) Filed: Jan. 3, 2025

(30) Foreign Application Priority Data
Mar. 4, 2024 (CN) 202420418648.X

(51) Int. Cl. F26B 21/00

(52) U.S. Cl. CPC F26B 21/50; F26B 21/003

(57) ABSTRACT

The present disclosure discloses an intake duct structure for a blow dryer, which includes a housing. The housing defines a housing intake port, and a blow dryer motor is arranged within the housing. It also includes an intake duct, one end of which is the duct intake port. The duct intake port is offset from the housing intake port, and the intake duct extends along the outer wall of the housing from the duct intake port to the housing intake port, such that the other end of the intake duct communicates with the housing intake port. The present disclosure also discloses a blow dryer. Through the above structural arrangement, the intake duct structure of the blow dryer is extended. The noise emitted by the blow dryer motor must pass through the housing intake port, the intake duct, and the duct intake port before propagating outward.

### TECHNICAL FIELD

The present disclosure relates to the field of pet products, and more specifically, to an intake duct structure for a blow dryer and the blow dryer itself.

### BACKGROUND

A blow dryer is a new product that has emerged in recent years, used for drying pet fur after a bath. As the product continues to evolve and improve, blow dryers are becoming increasingly compact in design. This has led to very limited structural space within the blow dryer, making the rational layout of components a technical challenge. In existing technologies, the compact design of the blow dryer allows it to be used closer to the operator, but this limited internal space also causes the motor noise to be more easily transmitted outward. As a result, users experience high motor noise during operation, which negatively affects the user experience. Over time, this noise may even contribute to noise-related health issues.

### SUMMARY

To overcome the shortcomings of the existing technology, the present disclosure provides an intake duct structure for a blow dryer and the blow dryer itself.

The technical solution to solve the technical problem is as follows:

The present disclosure provides an intake duct structure for a blow dryer, comprising a housing, where the housing is provided with a housing intake, and a blow dryer motor is arranged inside the housing.

The structure also includes an intake duct, one end of which is an intake port of the duct, which is offset from the housing intake.

The intake duct extends along the outer wall of the housing from the intake port of the duct to the housing intake, so that the other end of the intake duct communicates with the housing intake. The intake port of the duct is arranged on one side of the housing, and the housing intake is arranged on the opposite side of the housing, so that the intake duct forms a U-shape.

The present disclosure further includes a duct plate, which surrounds the outer wall of the housing to form the intake duct.

The duct plate comprises a first plate section and a second plate section, with the first plate section and the second plate section arranged at an angle to each other, surrounding the outer wall of the housing.

The housing includes a first housing unit and a second housing unit, which are arranged oppositely to form the housing. The housing intake is provided on the first housing unit, and the first plate section and the second plate section are arranged at an angle to surround the outer wall of the first housing unit.

The first plate section is integrally formed with the first housing unit, and the second plate section is integrally formed at the junction of the second housing unit and the first housing u nit.

Both the first plate section and the second plate section are arranged in a runway-like shape to surround the outer wall of the first housing unit. The intake port of the duct is located on the first plate section, and the first plate section extends from the intake port of the duct to form a duct starting plate. The first housing unit extends from the housing intake to form a duct end plate, so that the enclosed space between the duct starting plate and the duct end plate forms the intake duct.

The second housing unit extends to form a third plate section opposite to the second plate section. A runway-type storage channel is formed between the third plate section and the second plate section. The housing is provided with an air outlet, which is connected to a blow tube. The blow tube can be stored within the storage channel.

The intake port of the duct is provided with a filter. The present disclosure also provides a blow dryer, comprising the intake duct structure for the blow dryer as described above.

Beneficial effects of the present disclosure: through the structural arrangement described above, the intake port of the duct is offset from the housing intake, and the intake duct extends along the outer wall of the housing from the intake port of the duct to the housing intake, so that the other end of the intake duct communicates with the housing intake. This design extends the intake duct structure of the blow dryer.

The noise emitted by the blow dryer motor needs to pass through the housing intake, intake duct, and the intake duct port before it can propagate outward, thereby extending the path for noise propagation.

This helps filter and absorb the noise, providing an effective noise reduction effect and enhancing the user's operating experience. Moreover, the intake duct extending along the outer wall of the housing is also beneficial for the compact design of the blow dryer.

### BRIEF DESCRIPTION OF THE DRAWINGS

To better illustrate the technical solution of the embodiments of the present disclosure, the following provides a brief description of the accompanying drawings used in the embodiment description. The drawings below are only examples of some embodiments of the present disclosure, and those skilled in the art can, without creative effort, derive other drawings based on these. The present disclosure will be further explained with reference to the accompanying drawings and embodiments.

FIG. 1 is a schematic structural diagram of the present disclosure from one angle.

FIG. 2 is a schematic structural diagram of the present disclosure from another angle.

FIG. 3 is an exploded view of the present disclosure, where the first plate section and the first housing unit are separated.

FIG. 4 is an exploded view of the present disclosure, where the first plate section and the first housing unit are separated and flipped, with the dashed arrow lines indicating the direction of the intake duct.

FIG. 5 is a cross-sectional view of the present disclosure.

FIG. 6 is an enlarged view of section A in FIG. 5.

FIG. 7 is a longitudinal cross-sectional view of the present disclosure.

### DETAILED DESCRIPTION OF THE EMBODIMENTS

### Embodiment 1

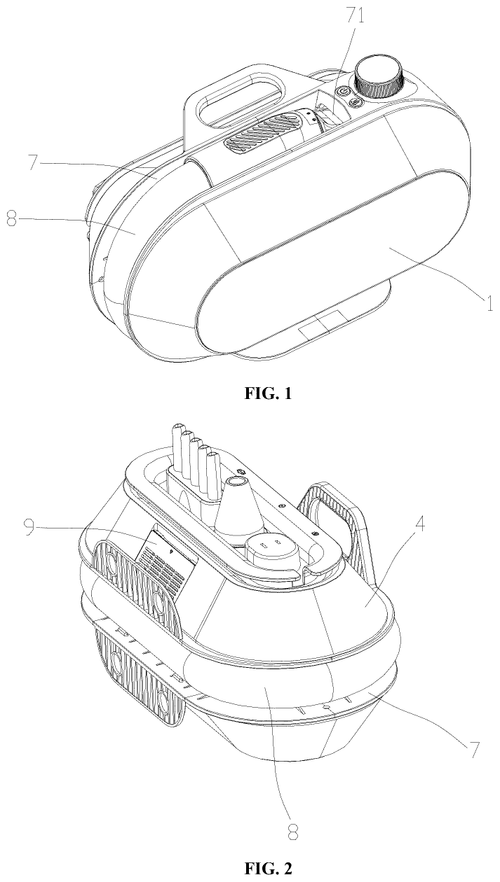

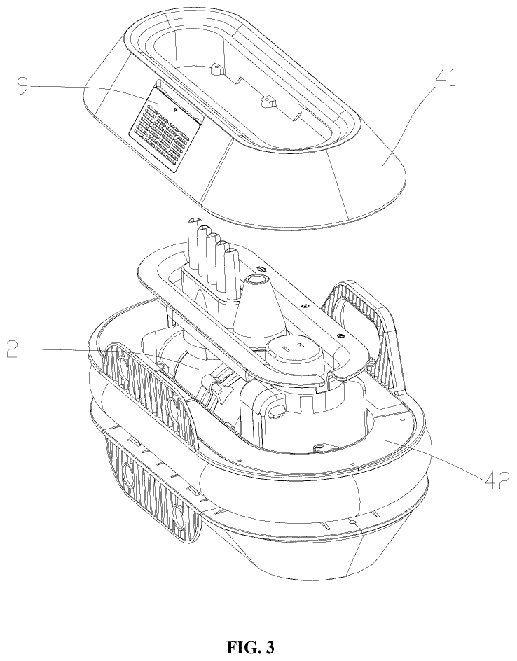

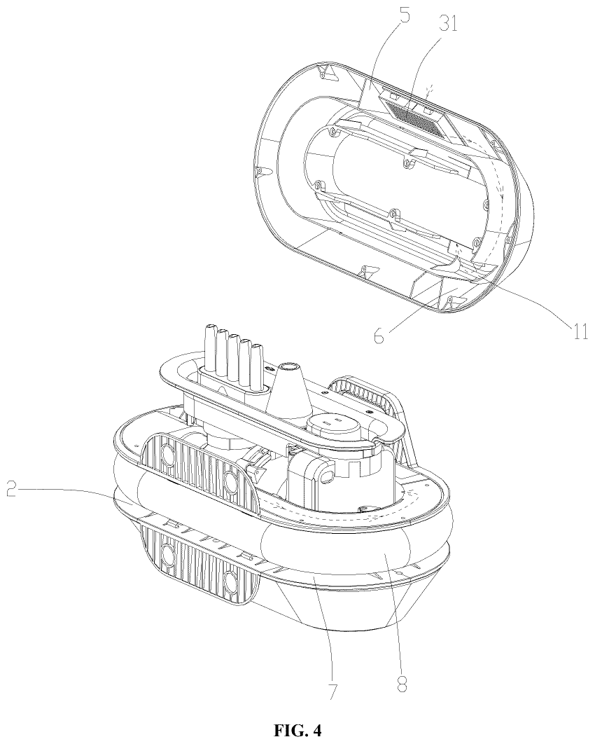

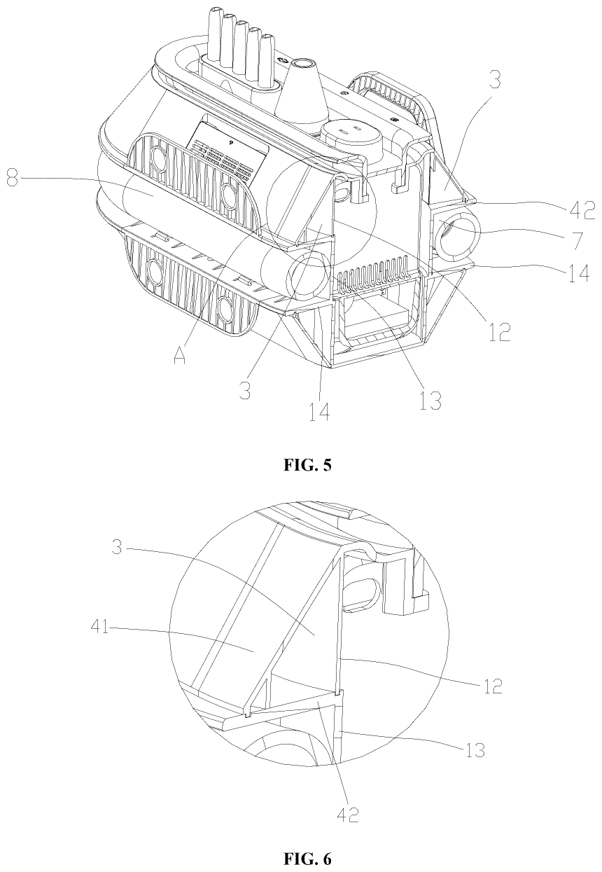

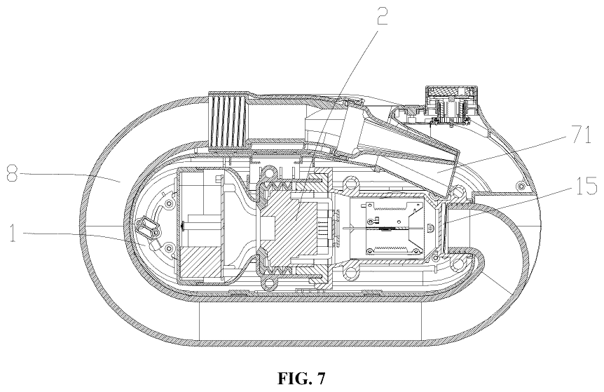

With reference to FIGS. 1 to 7, an intake duct structure of a blow dryer includes a housing 1, where the housing 1 defines a housing intake port 11, and a blow dryer motor 2 is arranged within the housing 1. The structure also includes an intake duct 3, one end of which is the duct intake port 31. The duct intake port 31 is offset from the housing intake port 11, and the intake duct 3 extends along the outer wall of the housing 1 from the duct intake port 31 to the housing intake port 11, such that the other end of the intake duct 3 communicates with the housing intake port 11.

Through this structural arrangement, the duct intake port is offset from the housing intake port, and the intake duct extends along the outer wall of the housing from the duct intake port to the housing intake port, allowing the other end of the intake duct to communicate with the housing intake port. This design extends the intake duct structure of the blow dryer. The noise emitted by the blow dryer motor has to pass through the housing intake port, intake duct, and the duct intake port before it can propagate outward. In other words, the path for noise propagation is lengthened, which helps filter and absorb the noise, providing an effective noise reduction effect and improving the user experience. Additionally, the extension of the intake duct along the housing's outer wall also supports the compact design of the blow dryer.

In this embodiment, the duct intake port 31 is arranged on one side of the housing 1, while the housing intake port 11 is arranged on the opposite side of the housing 1, forming a “U” shape for the intake duct 3. This design allows the intake duct to have a bent structure, further improving the noise filtering and absorption effect, and enhancing the product's noise reduction performance. This embodiment also includes a duct plate 4, which encloses the outer wall of the housing 1 to form the intake duct 3. Specifically, the duct plate 4 includes a first plate section 41 and a second plate section 42. The first plate section 41 and the second plate section 42 are arranged at an angle to each other to enclose the outer wall of the housing 1. This structure is simple and easy to assemble.

Furthermore, the housing 1 comprises a first housing unit 12 and a second housing unit 13, where the first housing unit 12 and the second housing unit 13 are arranged oppositely to form the housing 1. The housing intake port 11 is arranged on the first housing unit 12. The first plate section 41 and the second plate section 42 are arranged at an angle to each other to enclose the outer wall of the first housing unit 12. This design provides a rational structure and facilitates the assembly of the product.

Additionally, the first plate section 41 is integrally molded with the first housing unit 12, and the second plate section 42 is integrally molded at the junction of the second housing unit 13 and the first housing unit 12.

In this embodiment, the first plate section 41 and the second plate section 42 are both designed in a “track” shape to enclose the outer wall of the first housing unit 12. The duct intake port 31 is arranged on the first plate section 41, and the first plate section 41 extends into a duct start plate 5 corresponding to the duct intake port 31. The first housing unit 12 extends into a duct stop plate 6 corresponding to the housing intake port 11, so that the enclosed space between the duct start plate 5 and the duct stop plate 6 forms the intake duct 3.

Through this structural design, the “track” shape not only integrates with the intake duct structure but also enhances the appearance of the product.

Additionally, the second housing unit 13 extends outward to form a third plate section 14, positioned opposite the second plate section 42. The space between the third plate section 14 and the second plate section 42 forms a “track-shaped” storage channel 7. The housing 1 also includes an exhaust port 15, which is connected to a blow-drying tube 8. The blow-drying tube 8 can be stored within the storage channel 7.

Through this structural arrangement, when the blow dryer is not in use, the blow-drying tube can be conveniently stored within the storage channel. This design is simple and user-friendly. Specifically, the “track” design of the storage channel provides sufficient space for the blow-drying tube to be wound around the housing for storage. This allows the blow-drying tube to be designed long enough without taking up excessive space, optimizing the use of the product's structural space and supporting a more compact and convenient design. Furthermore, the storage channel can also include a storage hole 71 to accommodate the nozzle at the end of the blow-drying tube, further enhancing the ease of use for the operator.

In this embodiment, the duct intake port 31 is equipped with a filter mesh 9 to prevent foreign objects from entering the intake duct, thereby avoiding the potential ingress of debris into the blow dryer's housing (which contains the blow dryer motor). This helps extend the product's service life.

### Embodiment 2

With reference to FIGS. 1 to 7, a blow dryer includes the intake duct structure as described above. In this embodiment, since the blow dryer incorporates the intake duct structure as mentioned earlier, the duct intake port and the housing intake port are offset. The intake duct extends along the housing's outer wall from the duct intake port to the housing intake port, allowing the other end of the intake duct to connect to the housing intake port. This design effectively extends the intake duct structure of the blow dryer, with the noise from the motor passing through the housing intake port, intake duct, and duct intake port before propagating outward. In other words, the path for noise propagation is extended, aiding in the filtering and absorption of the noise, which results in effective noise reduction and enhances the user experience. Additionally, the extension of the intake duct along the outer wall of the housing also supports the blow dryer's compact design.

The embodiments provided above are examples of one or more possible implementations of the present disclosure and should not be considered limiting. Any modifications, substitutions, or variations that would be apparent to a person skilled in the art based on the disclosed concepts, methods, or structures, or those that involve technical deductions or replacements based on the original ideas of the present disclosure, should be considered within the scope of the protection of this present disclosure.

What is claimed is:

1. A blow dryer intake duct structure, comprising a housing (1), where the housing (1) is provided with a housing intake port (11), and the housing (1) is internally equipped with a blow motor (2), characterized in that it further includes an intake duct (3), one end of which is a duct intake port (31), the duct intake port (31) is offset from the housing intake port (11), and the intake duct (3) extends along the outer wall of the housing (1) from the duct intake port (31) to the housing intake port (11), such that the other end of the intake duct (3) communicates with the housing intake port (11).

2. The blow dryer intake duct structure of claim 1, wherein the duct intake port (31) is positioned on one side of the housing (1), and the housing intake port (11) is positioned on the opposite side of the housing (1), so that the intake duct (3) forms a “U”-shaped configuration.

3. The blow dryer intake duct structure of claim 1, comprising a duct plate (4), the duct plate (4) enclosing the outer wall of the housing (1) to form the intake duct (3).

4. The blow dryer intake duct structure of claim 3, wherein the duct plate (4) comprises a first plate portion (41) and a second plate portion (42), the first plate portion (41) and the second plate portion (42) are arranged at an angle to each other to enclose the outer wall of the housing (1).

5. The blow dryer intake duct structure of claim 4, wherein the housing (1) comprises a first housing unit (12) and a second housing unit (13), the first housing unit (12) and the second housing unit (13) are oppositely arranged to form the housing (1), the housing intake port (11) is provided in the first housing unit (12), and the first plate portion (41) and the second plate portion (42) are arranged at an angle to each other to enclose the outer wall of the first housing unit (12).

6. The blow dryer intake duct structure of claim 5, wherein the first plate portion (41) is integrally formed with the first housing unit (12), and the second plate portion (42) is integrally formed at the junction of the second housing unit (13) and the first housing unit (12).

7. The blow dryer intake duct structure of claim 5, wherein the first plate portion (41) and the second plate portion (42) are both configured in a runway shape to enclose the outer wall of the first housing unit (12).

8. The blow dryer intake duct structure of claim 7, wherein the duct intake port (31) is provided on the first plate portion (41), and the first plate portion (41) extends into a duct start plate (5) at the location corresponding to the duct intake port (31), the first housing unit (12) extends into a duct stop plate (6) at the location corresponding to the housing intake port (11), such that the enclosed space between the duct start plate (5) and the duct stop plate (6) forms the intake duct (3).

9. The blow dryer intake duct structure of claim 8, wherein the second housing unit (13) extends into a third plate portion (14) located opposite to the second plate portion (42), and a runway-shaped storage channel (7) is formed between the third plate portion (14) and the second plate portion (42).

10. The blow dryer intake duct structure of claim 9, wherein the housing (1) is provided with an exhaust port (15), which is connected to a blow pipe (8), and the blow pipe (8) can be stored within the storage channel (7).

11. The blow dryer intake duct structure of claim 1, wherein the duct intake port (31) is equipped with a filter (9).

12. A blow dryer, comprising the blow dryer intake duct structure as described in claim 1.
